(19) United States
(12) Patent Application Publication
(10) Pub. No.: US 2026/0079753 A1
(43) Pub. Date: Mar. 19, 2026

(54) METHOD AND DEVICE WITH ACCELERATOR CONTROL

(71) Applicant: Samsung Electronics Co., Ltd., Suwon-si (KR)

(72) Inventors: Hyungwoo LEE, Suwon-si (KR); Soon-Wan KWON, Suwon-si (KR)

(73) Assignee: Samsung Electronics Co., Ltd., Suwon-si (KR)

(21) Appl. No.: 19/256,002

(22) Filed: Jun. 30, 2025

(30) Foreign Application Priority Data
Sep. 13, 2024 (KR) 10-2024-0125534

(51) Int. Cl. G06F 9/50; G06F 7/02

(52) U.S. Cl. CPC G06F 9/5027; G06F 7/02; G06F 2209/508

(57) ABSTRACT

A method and device with accelerator control are provided. The method includes monitoring instructions processed in a core processor, identifying a loop including at least one instruction as an acceleration target while monitoring, comparing at least one piece of information corresponding to the loop that is the acceleration target with information managed in a table, and based on a result of the comparison, identifying configuration information corresponding to the loop, the configuration information controlling connection status of connections among a plurality of process elements (PEs) included in an accelerator.

### CROSS-REFERENCE TO RELATED APPLICATIONS

This application claims the benefit of Korean Patent Application No. 10-2024-0125534, filed on Sep. 13, 2024, in the Korean Intellectual Property Office, the disclosure of which is incorporated herein by reference in its entirety.

### BACKGROUND

### 1. Field

The following description relates to a method and device with accelerator control.

### 2. Description of Related Art

Reconfigurable architecture refers to an architecture in which the hardware configuration of a computing device is altered to optimize performance for each operation. Various types of reconfigurable architecture exist. Among these, a notable example is the coarse-grained reconfigurable array (CGRA) accelerator. The CGRA accelerator typically comprises multiple process elements (PEs), each capable of executing computations independently, with the function of each PE dynamically altered based on configuration data. Consequently, technologies that efficiently identify and manage this configuration information are essential for the effective operation of the CGRA accelerator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method include: monitoring instructions processed in a core processor; identifying, while monitoring, a loop comprising at least one instruction as an acceleration target; comparing at least one piece of information corresponding to the loop that is the acceleration target with information managed in a table; and based on a result of the comparison, identifying configuration information corresponding to the loop, the configuration information controlling connection status of connections among a plurality of process elements (PEs) included in an accelerator.

The identifying of the configuration information may further comprise, when at least one piece of information corresponding to the loop matches the information managed in the table, retrieving the configuration information corresponding to the loop from the table.

The identifying of the configuration information may further comprise, when at least one piece of information corresponding to the loop does not match the information managed in the table, generating new configuration information corresponding to the loop.

The method may further comprise updating the table to include the generated configuration information to be managed in the table.

The method may further comprise transmitting an updated table to another accelerator controller when the table is updated.

The at least one piece of information corresponding to the loop may comprise at least one of program counter information and hash information corresponding to the loop.

The hash information may be fixed length bit information that is determined based on the program counter information.

The method may further comprise transmitting the configuration information corresponding to the loop to the accelerator, wherein the accelerator processes the loop based on the transmitted configuration information.

The table may be stored in a first memory of the accelerator controller.

The configuration information corresponding to the loop may be managed in the table in the first memory when a size of the configuration information is less than a reference value.

In the method, when a size of the configuration information corresponding to the loop is equal to or greater than the reference value, identification information corresponding to the configuration information may be stored in the table in the first memory, and the configuration information may be stored in a second memory that is distinct from the first memory.

The configuration information may comprise a plurality of instructions for controlling connection status of the accelerator, and wherein multiple instructions among the plurality of instructions that are shared with another configuration information managed in the table are stored in a second memory that is distinct from the first memory.

The second memory may be updated and is accessible by other accelerator controllers.

The accelerator associated with the accelerator controller may be homogeneous with accelerators associated with the other accelerator controllers.

In one general aspect, provided non-transitory computer-readable recording medium storing executable code which, when executed by a computer, may cause the computer to perform the method described herein.

In one general aspect, an accelerator controller includes one or more processors respectively comprising processing circuitry; and a memory storing a table and executable code which, when executed by the one or more processors, configures the one or more processors to: monitor instructions processed in a core processor; identify, while monitoring, a loop comprising at least one instruction as an acceleration target; compare at least one piece of information corresponding to the loop with information managed in a table; and based on a result of the comparison, identify configuration information corresponding to the loop, the configuration information controlling connection status among a plurality of processing elements (Pes) included in an accelerator.

The one or more processors may be further configured to when at least one piece of information corresponding to the loop matches the information managed in the table, retrieve the configuration information corresponding to the loop from the table; and when at least one piece of information corresponding to the loop does not match the information managed in the table, generate new configuration information corresponding to the loop.

The at least one piece of information corresponding to the loop may comprise at least one of program counter information and hash information corresponding to the loop, wherein the hash information is fixed length bit information that is determined based on the program counter information.

The one or more processors may be further configured to transmit the configuration information corresponding to the loop to the accelerator, enabling the accelerator to process the loop.

In one general aspect, an electronic device includes a core processor; an accelerator controller configured to: monitor instructions processed in a core processor; identify, while monitoring, a loop comprising at least one instruction as an acceleration target; compare at least one piece of information corresponding to the loop that is the acceleration target with information managed in a table; and based on a result of the comparison, identify configuration information corresponding to the loop, the configuration information controlling connection status among a plurality of processing elements (PEs); and an accelerator comprising the plurality of Pes, wherein the connection status is controlled based on the configuration information, and wherein the accelerator is configured to process the loop based on the plurality of PEs.

Other features and aspects will be apparent from the following detailed description, the drawings, and the claims.

### BRIEF DESCRIPTION OF THE DRAWINGS

FIG. 1 illustrates a relationship among a core processor, an accelerator controller, and an accelerator according to one or more embodiments.

FIG. 2 illustrates information corresponding to a loop as an acceleration target according to one or more embodiments.

FIG. 3 illustrates a table stored in a first memory according to one or more embodiments.

FIG. 4 illustrates a process for efficiently managing configuration information according to one or more embodiments.

FIG. 5 illustrates a flowchart for processing an instruction that serves as an acceleration target according to one or more embodiments.

FIG. 6 illustrates an update of the first memory or the second memory according to one or more embodiments.

FIG. 7 is a flowchart illustrating an operation method of an accelerator controller according to one or more embodiments.

FIG. 8 is a block diagram illustrating an accelerator controller according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

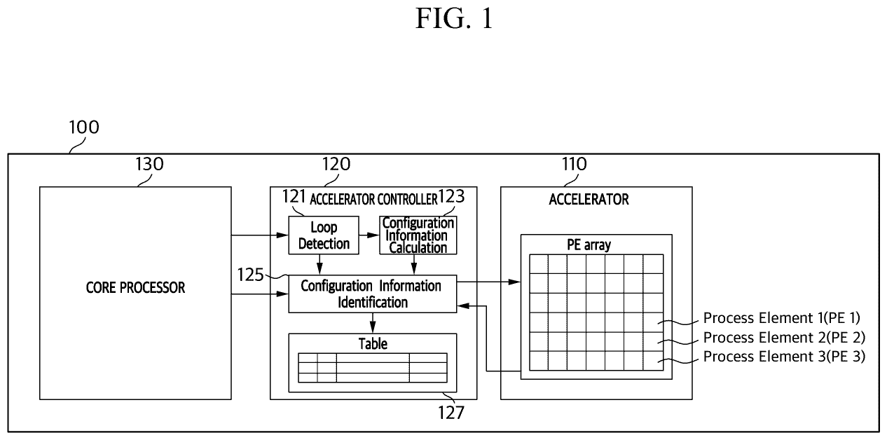

FIG. 1 illustrates a relationship among a core processor, an accelerator controller, and an accelerator according to one or more embodiments.

Referring to FIG. 1, an electronic device 100 may include at least one of an accelerator 110, an accelerator controller 120, and a core processor 130. The electronic device 100 may form part of a computing system configured to process data.

It will be understood by those skilled in the art that the electronic device 100 may further include additional general-purpose components (not shown in FIG. 1).

The accelerator 110 may include a plurality of processing elements (Pes) arranged in array, wherein each PE is configured to perform computation. In an example, the accelerator 110 may include a coarse-grained reconfigurable array (CGRA) accelerator.

A computation type executed by a PE within the accelerator 110 and connectivity (e.g., connection status) among PEs may be controlled based on configuration information. For example, a computation type performed by a first PE (PE1) and its connection status of connections with other PEs (e.g., PE2 and PE3) may be controlled to be dynamically reconfigured based on configuration information. Thus, optimal configuration information is required to accelerate processing of the loop (i.e., a target loop) that is the target of acceleration.

The accelerator controller 120 is configured to identify and transmit the configuration information to the accelerator 110. In an example, the accelerator controller 120 may perform three primary operations: loop detection 121, configuration information calculation 123, and configuration information identification 125. Each operation is described in detail below.

During operation, the accelerator controller 120 may monitor a plurality of instructions processed by the core processor 130. While monitoring, the accelerator controller 120 may perform the loop detection 121 to identify a target loop comprising at least one instruction designated for acceleration. In an example, the loop detection 121 may correspond to the operation of detecting a loop containing at least one instruction as an acceleration target, among the plurality of instructions processed by the core processor 130.

Upon detecting a target loop that is an acceleration target, the accelerator controller 120 executes the configuration information calculation 123 to generate new configuration information corresponding to the target loop so that the target loop may be processed by the accelerator 110. Here, the configuration information optimizes computation types and connection status among PEs in the accelerator 110 for each loop. When there are many instructions included in the loop that is the acceleration target, the size of the configuration information that the accelerator controller 120 calculates in response to the loop is large, and thus it may require extended calculation times due to increased configuration information complexity.

Accordingly, to expedite processing, the accelerator controller 120 may manage at least one configuration information processed in the past through a table 127, and make a determination of whether the configuration information corresponding to the currently detected loop exists in the table 127.

When the configuration information is present in the table 127, the configuration information identification 125 may perform an operation of identifying and retrieving the configuration information based on the table 127. When the configuration information is absent in the table 127, the configuration information identification 125 may perform an operation of identifying and using the newly calculated configuration information from the configuration information calculation 123 as the configuration information corresponding to the loop. Accordingly, the accelerator controller 120 may transmit the identified configuration information to the accelerator 110.

Here, the accelerator 110 may quickly process a loop detected by controlling and reconfiguring the PEs based on the configuration information obtained from the accelerator controller 120. The accelerator 110 may transmit a plurality of pieces of information identified during loop processing to the accelerator controller 120. Accordingly, the accelerator controller 120 may be used in the process of deriving more optimal configuration information for each loop based on the plurality of pieces of information received from the accelerator 110, enabling iterative optimization of future configuration information.

Here, the core processor 130, such as a central processing unit (CPU), may control the electronic device 100 and executes program computations related to all the operations and methods described herein.

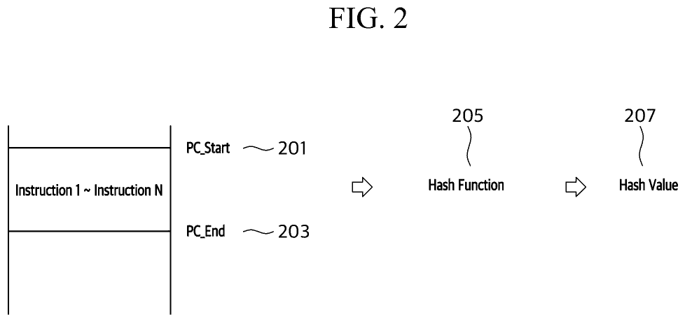

FIG. 2 illustrates information corresponding to a loop as an acceleration target according to one or more embodiments.

Referring to FIG. 2, a loop comprising at least one instruction among a plurality of instructions processed by a core processor may be detected as an acceleration target. Here, a target loop comprises instructions between a start program counter (PC_Start 201) and an end program counter (PC_End 203). The PC_Start 201 corresponds to the first instruction (Instruction 1) of the loop, and the PC_End 203 corresponds to the last instruction (Instruction N).

Here, the number of instructions contained in a loop may vary from loop to loop, and the length of the corresponding bits for each loop may be different. Accordingly, to standardize variable-length loops, a hash function 205 may convert loop instructions into a fixed-length hash value 207. For example, when the hash function 205 is applied to a loop 1 and a loop 2 with different bit lengths, a hash value corresponding to the loop 1 and a hash value corresponding to the loop 2 may be different, but the bit lengths of the hash values may be the same. Thus, distinct loops of differing lengths yield unique hash values of uniform bit length.

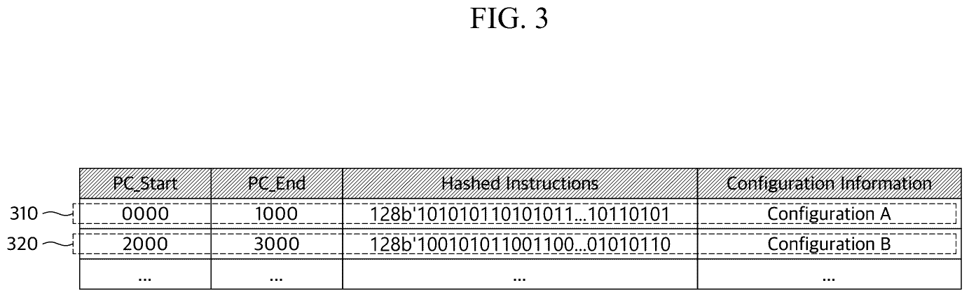

FIG. 3 illustrates a table stored in a first memory according to one or more embodiments.

Referring to FIG. 3, the table may include entries that associate program counter information, hashed instructions, and configuration information.

With regard to the program counter information (e.g., PC_Start and PC_End), the description provided in connection with FIG. 2 is applicable. The hashed instructions may represent a fixed-length hash value converted based on a hash function, and the configuration information may correspond to parameters derived from previous calculations corresponding to a relevant loop.

In one embodiment, when processing a plurality of instructions in the core processor, when at least one of the program counter information or the hash information corresponding to the target loop that is the acceleration target matches a corresponding one element of information/instruction (e.g., PC_Start, PC_End, or the hashed instructions) managed/stored in the table, the accelerator controller may identify/retrieve the associated configuration information from the table and forward/pass the configuration information to the accelerator. Conversely, when no such match is found, the accelerator controller may compute new configuration information and transmit the newly generated configuration information to the accelerator. In an example, both the program counter information and the hash information may be used as comparison targets to enhance matching reliability.

In one embodiment, the table stores/manages identification information 310 indicating that PC_Start is “0000,” PC_End is “1000,” the hashed instructions are represented by a 128-bit hash value, and the corresponding configuration information is designated as Configuration A. Accordingly, when a loop is detected while monitoring the core processor, if any element corresponding to the loop matches an element (i.e., program counter information or hashed instructions) stored in the identification information 310, the accelerator controller may transmit the identified Configuration A to the accelerator without recalculating configuration information. If no match is detected, the accelerator controller may compute new configuration information and transmit the newly generated configuration information to the accelerator.

In one embodiment, the table stores identification information 320 indicating that PC_Start is “2000,” PC_End is “3000,” the hashed instructions are represented by a 128-bit hash value, and the associated/corresponding configuration information is designated as Configuration B. Accordingly, when a loop is detected while monitoring the core processor, if any element corresponding to the loop matches an element stored in the identification information 320, the accelerator controller may transmit the identified Configuration B to the accelerator without recalculating configuration information. If no match is detected, the accelerator controller may compute new configuration information and transmit the newly generated configuration information to the accelerator.

In one embodiment, the number of configuration information entries managed/stored in the table may depend on the capacity (e.g., a size) of the first memory storing the table. For example, when the first memory has a large capacity, a greater number of configuration information entries may be managed in the table compared to when the size of the first memory is smaller.

The hashed instructions may be a fixed-length hash value generated/converted based on at least one instruction contained between PC_Start and PC_End. For example, the hashed instructions may be derived from all instructions included between PC_Start and PC_End.

However, when the number of instructions included between PC_Start and PC_End exceeds a predetermined threshold (e.g., a standard number), the hashed instruction may be a fixed-length hash value generated/converted based on a subset of instructions selected according to one or more criterion among the instructions included between PC_Start and PC_End. Consequently, using a subset of instructions can improve the processing speed of the accelerator controller compared to using all instructions located between PC_Start and PC_End.

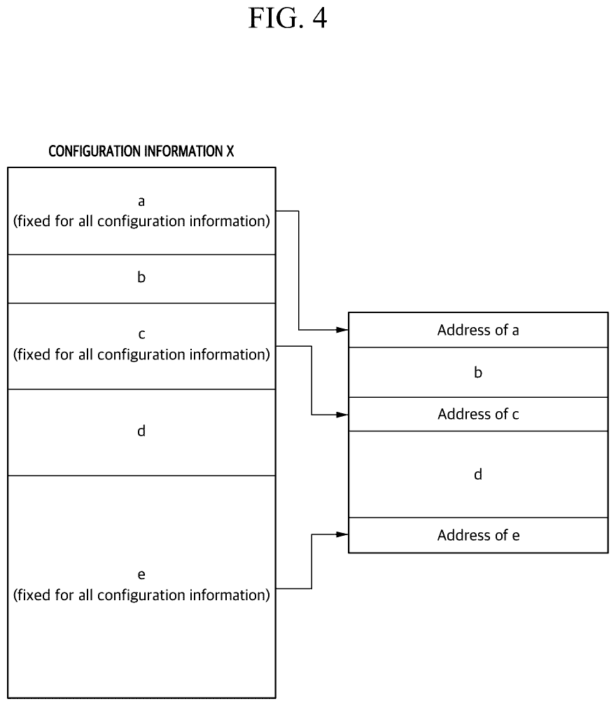

FIG. 4 is a diagram illustrating a process for efficiently managing configuration information according to one or more embodiments.

In one embodiment, the data size of configuration information may be larger than that of PC_Start, PC_End, and hashed instructions managed in a table. Accordingly, when the size of configuration information is less than a predetermined reference value, the configuration information may be managed in the first memory that stores the table. However, when the size of the configuration information is equal to or greater than the reference value, identification information corresponding to configuration information may be stored/managed in the first memory, while the configuration information itself may be managed in a second memory that is separate from the first memory. This arrangement addresses the need to efficiently manage large configuration information.

Referring to FIG. 4, the configuration information may comprise at least one instruction, wherein some instructions of the at least one instruction may be common to other configuration information. For example, configuration information X may comprise instructions a, b, c, d and e, with instructions a, c and e being common to configuration information X as well as to other configuration information.

In configuration information X, the instructions a, c and e are shared with other configuration information. By managing the address information for these shared instructions (a, c, and e) in combination with the full instructions for the nonshared instructions (b and d), the overall size of configuration information X is reduced compared to managing configuration information X by storing the full instruction data for all instructions a, b, c, d and e. In other words, because the full instruction data for instructions a, b, and c occupies more memory than the corresponding address information, substituting the address information for the shared instructions results in a reduction in the size of configuration information X.

In one embodiment, the address information for instructions may be managed in the first memory (which contains a table), while the full instructions corresponding to the address information may be stored/managed in a second memory that is separate or distinct from the first memory. For example, the addresses of instructions a, c, and e may be maintained/managed in the first memory, and based on this address information, the full instructions for a, c, and e may be identified and retrieved from the second memory.

Therefore, the address information corresponding to an instruction shared among multiple configuration information sets may be managed in a table within the first memory, while the full instructions corresponding to that address information are stored/managed in the second memory that is separate or distinct from the first memory. In contrast, instructions that are not shared with other configuration information may be stored in full in the first memory. Consequently, by reducing the overall size of the configuration information, the table can more efficiently manage the configuration information.

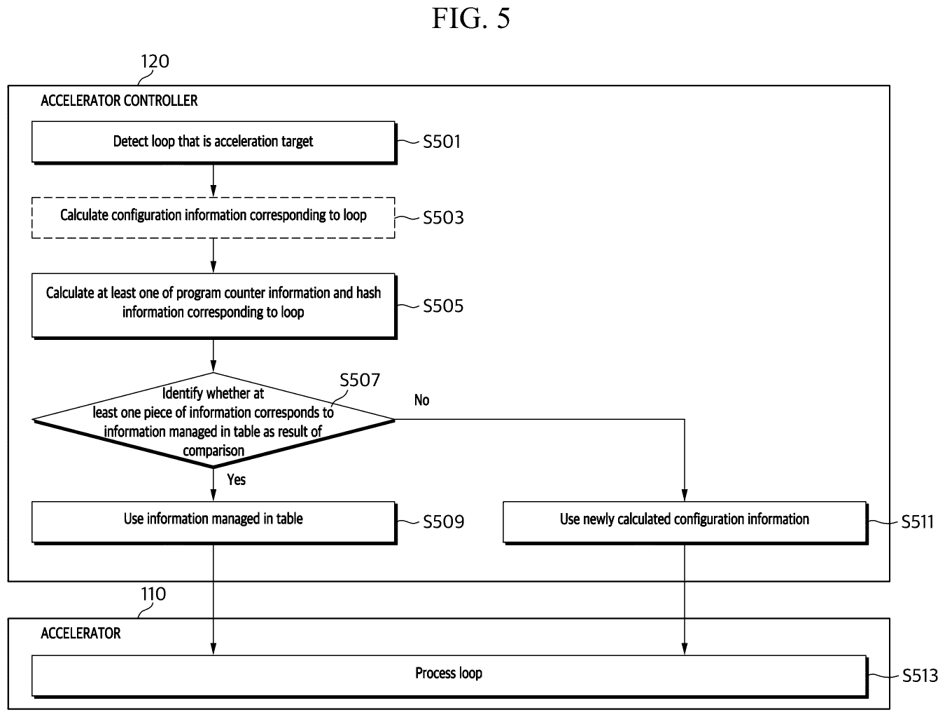

FIG. 5 illustrates a flowchart for processing an instruction that serves as an acceleration target according to one or more embodiments.

Referring to FIG. 5, in operation S501, the accelerator controller 120 may detect a loop that is an acceleration target while monitoring instructions processed by the core processor. The detected loop comprises at least one instruction and can be efficiently processed by the accelerator 110.

In operation S503, the accelerator controller 120 may calculate configuration information corresponding to the detected loop. In operation S505, the accelerator controller 120 may determine/calculate program counter information and/or hash information corresponding to the loop. The program counter information may include the above described PC_Start and PC_End, while the hash information may include the hashed instructions described above.

In operation S507, the accelerator controller 120 may identify/verify whether at least one element of the program counter information or hash information corresponding to the loop matches a corresponding element of information stored/managed in the table. When a match is found as a result of the comparison, the process proceeds to operation S509. When no match is found, the process advances to operation S511.

In one embodiment, operation S509 may be performed when either the program counter information or the hash information corresponding to the loop matches the corresponding information stored/managed in the table. To enhance matching reliability, operation S509 may be performed only when both the program counter information and the hash information match the corresponding information stored/managed in the table.

In operation S509, the accelerator controller 120 may use the configuration information stored/managed in the table. In other words, rather than recalculating configuration information as in operation S503, the accelerator controller 120 may retrieve and apply the configuration information that has been pre-existed in the table.

In operation S511, the accelerator controller 120 may use newly calculated configuration information. Since no corresponding/relevant information was found in the table, in operation S511, the accelerator controller 120 may rely on the configuration information determined in operation S503. The newly computed configuration information is then updated and stored/managed in the table for future use.

In operation S513, the accelerator 110 may obtain/acquire the identified configuration information from the accelerator controller 120 based on the information(data) stored in the table per operation S509. Using this configuration information, the accelerator 110 may efficiently process the loop, which serves as an acceleration target, by controlling the connection status among multiple PEs. Alternatively, if the process followed operation S511, the accelerator 110 may obtain the newly calculated configuration information from the accelerator controller 120 and efficiently process the loop, which is an acceleration target, by managing the connection status among multiple PEs.

In one embodiment, the accelerator controller 120 may bypass (not execute) operation S503, which involves calculating the configuration information. In other words, the accelerator controller 120 may not initiate configuration information calculation unless no corresponding data is found in the table per operation S507. If the configuration information calculation process, such as in operation S503, is not initiated, then the accelerator controller 120 does not need to halt such calculations in operation S509. This approach optimizes power management in the accelerator controller 120 by reducing unnecessary computational processes.

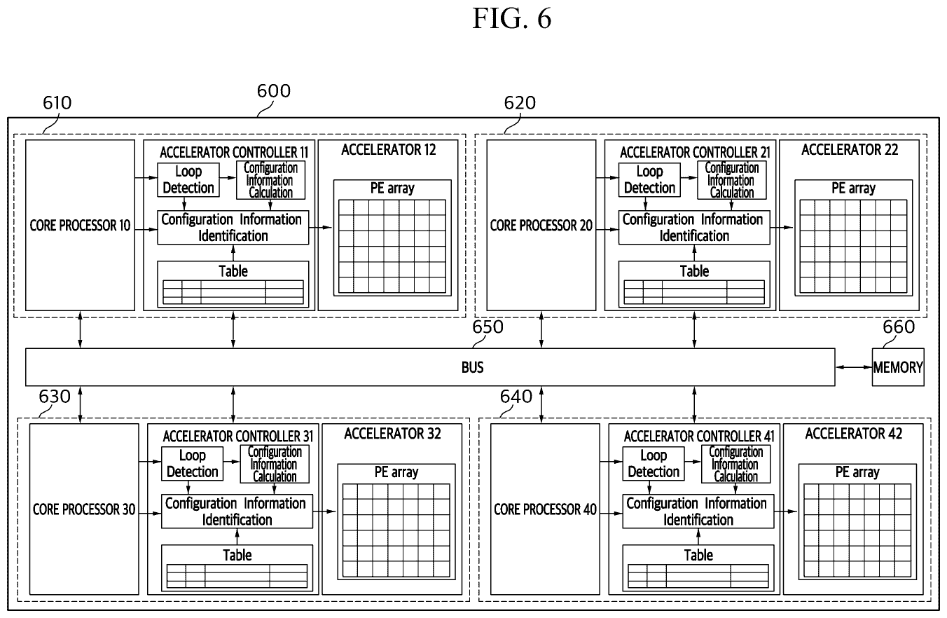

FIG. 6 illustrates an update of the first memory or the second memory according to one or more embodiments.

Referring to FIG. 6, a computing system 600 may include one or more electronic devices 610, 620, 630 and 640, a bus 650, and a memory 660. It will be understood by those skilled in the art that the computing system 600 may include additional components beyond those illustrated in FIG. 6. The bus 650 may serve as a data path for transferring information between components. The illustrated electronic devices are provided by way of example only, and the scope of the present disclosure is not limited thereto. Where the core processor, accelerator controller, and accelerator are incorporated into the electronic devices 610, 620, 630, and 640, redundant descriptions have been omitted for brevity.

In one embodiment, within the electronic device 610, an accelerator controller 11 may monitor instructions processed by core processor 10 and identify a loop, which comprises at least one instruction, as an acceleration target. Descriptions with respect to the electronic device 610 may also apply to other electronic devices 620, 630 and 640, and thus repetitive descriptions are omitted.

In operation, when at least one element of the program counter information or the hash information corresponding to the acceleration target loop matches a corresponding information element stored/managed in the table, the connection status among a plurality of PEs within the accelerator 12 may be controlled based on the configuration information stored/managed in the table. In other words, by using the pre-stored configuration information, the accelerator 12 can process the acceleration target loop more rapidly without recalculating the configuration information.

Alternatively, if neither the program counter information nor the hash information for the acceleration target loop corresponds to the information managed in the table as a result of the comparison, new configuration information for the loop is calculated, and the connection status among the plurality of PEs within the accelerator 1 is then controlled based on this newly calculated configuration information. In other words, using the newly calculated configuration information, the accelerator 1 may process the loop, which is the acceleration target. Here, the newly calculated configuration information is subsequently stored in the table to update it.

The table may be managed in the first memory of the accelerator controller 11. When the table is updated, the electronic device 610 may transmit the updated table to one or more of the electronic devices 620, 630 and 640. Accordingly, the electronic devices 620, 630 and 640 may also manage the updated table in their respective first memories, enabling rapid identification of configuration information even when it is not recalculated.

In one embodiment, each accelerator controller includes its own first memory, while the memory 660 corresponds to the second memory. For example, when the size of the configuration information stored/managed in the table is equal to or exceeds a predetermined reference value, identification information corresponding to the configuration information may be stored/managed in the first memory's table, and the corresponding configuration information may be stored/managed in the second memory (i.e., memory 660). Therefore, when the size of the configuration information meets or exceeds the reference value, the accelerator controller may identify/retrieve the configuration information from the second memory using the identification information from the first memory. Conversely, when the size of configuration information is less than the reference value, it is stored/managed entirely in the table in the first memory, allowing the accelerator controller to access it without engaging the second memory.

Each accelerator controller contains its own first memory; however, the second memory (memory 660) may be accessible by all accelerator controllers without restrictions. In an example, the accelerator controller 11, an accelerator controller 21, an accelerator controller 31 and an accelerator controller 41 may access the memory 660 as needed.

Here, the first memory and the second memory may comprise any suitable volatile memory or non-volatile memory devices. For example, the second (memory 660) may be implemented as dynamic random access memory (DRAM) or any equivalent hardware for storing related information. Similarly, the first memory, which stores and manages the table, may be implemented as static random access memory (SRAM) or any other appropriate memory technology. The implementations are not limited to DRAM or SRAM.

When the table included in the accelerator controller 11 is updated, homogeneous accelerators—such as accelerator 12, accelerator 22, accelerator 32, and accelerator 42—may utilize the updated table without recalculating configuration information. In such cases, accelerator controllers 21, 31, and 41 can adopt the updated table from accelerator controller 11. However, if the accelerators are not homogeneous, a corresponding accelerator controller may not be able to use the configuration information contained in the updated table. Here, when only the dimensions among accelerators are different, the accelerators may be considered homogeneous; if differences extend beyond mere dimensions, the accelerators may be regarded as non-homogeneous.

In one embodiment, the computing system 600 and one or more of the electronic devices 610, 620, 630 and 640 may be interconnected via chiplet(s). In such configurations, the updated table may also be shared with other homogeneous computing systems or other homogeneous electronic devices connected through chiplets. Thus, when the table is updated in any one of the computing system 600 or the electronic devices 610, 620, 630 and 640, the updated table may be shared with other homogeneous computing systems or other electronic devices, enabling them to utilize the configuration information without recalculation.

In another embodiment, updated tables may be shared among homogeneous electronic devices within a single system-on-chip (SoC). When the table is updated in at least one of the computing system 600 and the electronic devices 610, 620, 630 and 640 within the SoC, the updated table may be distributed to and shared with other homogeneous computing systems or other electronic devices connected by the SoC. Consequently, these systems or devices can use the configuration information contained in the shared table without the need to recalculate it.

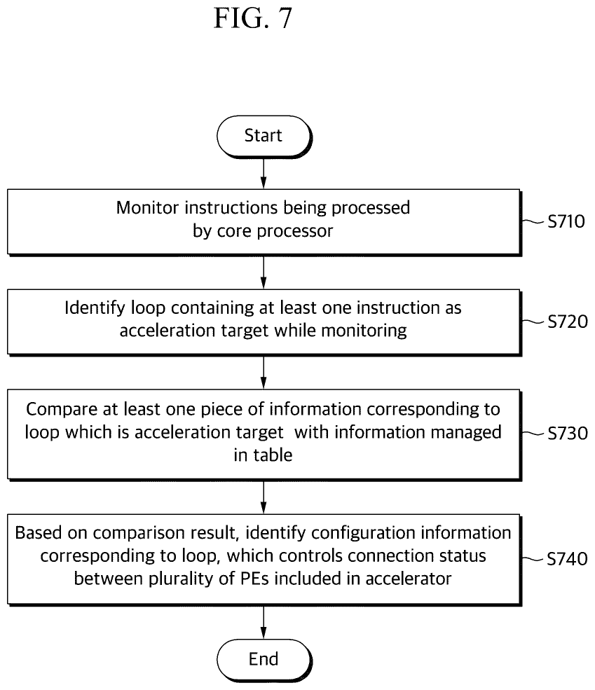

FIG. 7 is a flowchart illustrating an operation method of an accelerator controller according to one or more embodiment.

Referring to FIG. 7, in operation S710, the accelerator controller may monitor a plurality of instructions processed by the core processor. In operation S720, while monitoring, the accelerator controller may identify a loop containing at least one instruction as an acceleration target. In other words, the accelerator controller may detect loops, as acceleration targets, destined for rapid processing by the accelerator, among the plurality of instructions executed by the core processor.

In operation S730, the accelerator controller may compare at least one piece of information corresponding to the loop, which is the acceleration target, with the information stored/managed in the table. Here, the table may be maintained in the first memory included in the accelerator controller.

The at least one piece of information corresponding to the loop may include at least one of program counter information and hash information.

The program counter information may include at least one among PC_Start corresponding to the first instruction (instruction 1) to PC_End corresponding to the last instruction (instruction N) included in the loop, which is the acceleration target.

The hash information may include fixed-length bit information derived from the program counter information. The number of instructions included in the loop that is an acceleration target may vary with respect to each loop, resulting in loops of different bit lengths. However, loops of different bit lengths may be converted into uniform-length hash information by a hash function.

As described with reference to FIG. 2 and FIG. 3, the accelerator controller may compare whether at least one piece of information corresponding to the loop which is an acceleration target matches the information stored/managed in the table.

The table may store, for each loop, at least one piece of loop information and its corresponding configuration information. Here, when the size of the configuration information corresponding to the loop is less than a predetermined reference value, the configuration information is stored/managed in the table within the first memory. Alternatively, when the size of the configuration information corresponding to the loop is equal to or greater than the reference value, identification information corresponding to configuration information is stored/managed in the table within the first memory, while the full configuration information is stored/managed in a second memory that is separate from the first memory. Unlike the first memory included in the accelerator controller, the second memory may be accessible by other accelerator controllers. Consequently, when the second memory is updated, the updated/revised configuration information becomes accessible to both the local and other accelerator controllers. If the table in the first memory is updated, the updated table may be transmitted from one accelerator controller to another, allowing the receiving controller to use the updated table.

The accelerators associated with the respective accelerator controllers may be homogeneous. Accelerators are considered homogeneous if they differ only in dimensions; otherwise, they may be deemed heterogeneous.

The configuration information may include a plurality of instructions for controlling the connection status of the accelerator, and some of the plurality of instructions may be common to other configuration information. Instructions shared with other configuration information are stored/managed in a second memory that is separate from the first memory, and instructions that are not shared with other configuration information are managed in the first memory, thereby promoting efficient management of configuration information.

In operation S740, based on the comparison result, the accelerator controller may identify the configuration information corresponding to the loop, which controls the connection status among a plurality of PEs within the accelerator.

When at least one piece of information corresponding to the loop matches the information managed in the table as a result of the comparison, the accelerator controller may identify/retrieve the configuration information corresponding to the loop from the table.

Alternatively, if no matching information is found in the table, the accelerator controller may calculate and generate new configuration information for the loop. Here, the accelerator controller may update the table to include the newly generated configuration information in the table. Following an update, the accelerator controller may transmit the revised table to other accelerator controllers, enabling them to utilize the updated configuration information.

Once the configuration information for the loop is identified (whether retrieved from the table or newly generated), the accelerator controller transmits it to the accelerator, allowing the accelerator to process the loop efficiently.

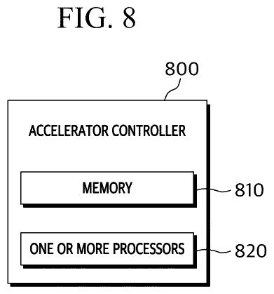

FIG. 8 is a block diagram illustrating an accelerator controller according to one or more embodiments.

Referring to FIG. 8, an accelerator controller 800 may include a memory 810 and one or more processors 820 respectively comprising processing circuitry. It will be understood by those skilled in the art related to the present example embodiment that additional components may be included into the accelerator controller 800 beyond those illustrated in FIG. 8. The above descriptions with respect to the accelerator controller may be applied to the accelerator controller 800, and thus repetitive descriptions are omitted.

In one embodiment, the one or more processors 820 may control the overall operation of the accelerator controller 800 by processing data and signals. In an example, the one or more processors 820 may use information stored in the memory 810 to manage the controller's functions.

The memory 810 may manage tables comprising program counter information, hash information, and configuration information. The one or more processors 820 may monitor instructions executed by the core processor, and identify a loop comprising at least one instruction as an acceleration target during monitoring. The one or more processors 820 may compare at least one piece of information corresponding to the acceleration target loop with the information managed in the table. Based on the result(s) of the comparison, the processor 820 may identify the configuration information associated with the loop. This configuration information is subsequently used to control the connection status among a plurality of processing elements (PEs) within the accelerator.

Here, as a result of the comparison, when at least one piece of information corresponding to the loop matches information stored/managed in the table, the one or more processors 820 may identify/retrieve the configuration information corresponding to the loop from the table. Conversely, when no match is found, the one or more processors 820 may calculate and generate new configuration information for the loop, and update the table so that the newly generated configuration information is managed in the table. The accelerator controller may transmit the configuration information to the accelerator, which uses it to control the connection status among at least multiple Pes of a plurality of PEs and process the loop efficiently.

When the table is updated, the accelerator controller 800 may transmit the updated table to other accelerator controllers, enabling them to use the updated configuration information contained in the updated table. In this context, the accelerator associated with the accelerator controller 800 and the accelerators associated with the other accelerator controllers are homogeneous rather than heterogeneous.

Further, the information corresponding to the loop may include at least one of program counter information and hash information, wherein the hash information may be represented by fixed-length bit data derived from the program counter information.

When the size of the configuration information corresponding to the loop is less than a predetermined reference value, the configuration information is managed directly in a table included in the memory 810. Alternatively, when the size of the configuration information corresponding to the loop is equal to or exceeds the reference value, identification information corresponding to the configuration information is managed in the table within the memory 810, while the full configuration information that is equal to or exceeds the reference value corresponding to the identification information is stored/managed in a separate memory distinct from the memory 810.

Alternatively, the configuration information may include a plurality of instructions for controlling the connection status of the accelerator. Instructions common to multiple configuration datasets are managed in a separate memory (not illustrated) that is distinct from memory 810, while instructions unique to a specific configuration are maintained in memory 810. This approach facilitates more efficient management of the configuration information.

The processors, memories, electronic devices, controllers, and accelerators described herein, including descriptions with respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software include higher-level code that is executed by the one or more processors or computers using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method of operating an electronic device including an accelerator controller, the method comprising:
monitoring instructions processed in a core processor;
identifying, by the monitoring, a loop comprising at least one instruction as an acceleration target;
comparing at least one piece of information corresponding to the loop that is the acceleration target with information managed in a table; and
based on a result of the comparison, identifying configuration information corresponding to the loop, the configuration information controlling connection statuses of connections among process elements (PEs) included in an accelerator controlled by the accelerator controller.

2. The method of claim 1, wherein the identifying of the configuration information further comprises:
when at least one piece of information corresponding to the loop matches the information managed in the table, retrieving the configuration information corresponding to the loop from the table.

3. The method of claim 1, wherein the identifying of the configuration information further comprises:
when at least one piece of information corresponding to the loop does not match the information managed in the table, generating new configuration information corresponding to the loop.

4. The method of claim 3, further comprising updating the table to include the generated configuration information to be managed in the table.

5. The method of claim 4, further comprising transmitting the updated table to other accelerator controllers.

6. The method of claim 1, wherein the at least one piece of information corresponding to the loop comprises at least one of program counter information and hash information corresponding to the loop.

7. The method of claim 6, wherein the hash information is fixed length bit information that is determined based on the program counter information.

8. The method of claim 1, further comprising transmitting the configuration information corresponding to the loop to the accelerator, wherein the accelerator processes the loop based on the transmitted configuration information.

9. The method of claim 5, wherein the table is stored in a first memory of the accelerator controller.

10. The method of claim 9, wherein the configuration information corresponding to the loop is managed in the table in the first memory when a size of the configuration information is less than a reference value.

11. The method of claim 9, wherein, when a size of the configuration information is equal to or greater than the reference value, identification information corresponding to the configuration information is stored in the table in the first memory, and the configuration information is stored in a second memory that is distinct from the first memory.

12. The method of claim 9, wherein the configuration information comprises a plurality of instructions for controlling connection status of the accelerator, and
wherein multiple instructions, among the plurality of instructions, that are shared with another configuration information managed in the table are stored in a second memory that is distinct from the first memory.

13. The method of claim 9, wherein the second memory is updated and is accessible by the other accelerator controllers.

14. The method of claim 13, wherein the accelerator, which is controlled by the accelerator controller, is homogeneous with accelerators, which are respectively controlled by the other accelerator controllers.

15. A non-transitory computer-readable recording medium storing executable code that, when executed by a computer, causes the computer to perform the method of claim 1.

16. An accelerator controller comprising:
one or more processors respectively comprising processing circuitry; and
a memory storing executable code that, when executed by the one or more processors, configures the one or more processors to:
monitor instructions processed in a core processor;
identify, by the monitoring, a loop comprising at least one instruction as an acceleration target;
compare at least one piece of information corresponding to the loop with information managed in a table; and
based on a result of the comparison, identify configuration information corresponding to the loop, the configuration information controlling connection status of connections among a plurality of processing elements (PEs) included in an accelerator.

17. The accelerator controller of claim 16, wherein the one or more processors are further configured to:
when at least one piece of information corresponding to the loop matches the information managed in the table, retrieve the configuration information corresponding to the loop from the table; and
when at least one piece of information corresponding to the loop does not match the information managed in the table, generate new configuration information corresponding to the loop.

18. The accelerator controller of claim 16, wherein the at least one piece of information corresponding to the loop comprises at least one of program counter information and hash information corresponding to the loop,
wherein the hash information is fixed length bit information that is determined based on the program counter information.

19. The method of claim 16, wherein the one or more processors are further configured to transmit the configuration information corresponding to the loop to the accelerator, enabling the accelerator to process the loop.

20. An electronic device comprising:
a core processor;
an accelerator controller configured to:
monitor instructions processed in a core processor;
identify, by monitoring, a loop comprising at least one instruction as an acceleration target;
compare at least one piece of information corresponding to the loop that is the acceleration target with information managed in a table; and
based on a result of the comparison, identify configuration information corresponding to the loop, the configuration information controlling connection status of connections among a plurality of processing elements (PEs); and
an accelerator comprising the plurality of Pes, wherein the connection status is controlled based on the configuration information, and wherein the accelerator is configured to process the loop based on the plurality of PEs.
